(19) United States
(12) Patent Application Publication
(10) Pub. No.: US 2014/0371642 A1
(43) Pub. Date: Dec. 18, 2014

(54) HYDROMASSAGE CHAIR FOR SWIMMING POOLS AND THE LIKE

(71) Applicants: José Torregrosa Pascual, (US); Domingo Torregrosa Pascual, (US)

(72) Inventor: José Torregrosa Pascual, Murcia (ES)

(21) Appl. No.: 14/361,584

(22) PCT Filed: Oct. 22, 2012
(86) PCT No.: PCT/ES2012/000269

§ 371 Date: May 29, 2014

(30) Foreign Application Priority Data
Dec. 1, 2011 (ES) U201101147

(51) Int. Cl. A61H 9/00

(52) U.S. Cl. CPC A61H 9/0071; A61H 2201/0115
USPC 601/158

(57) ABSTRACT

A chair having a backrest, a seat and a footrest, and also a headrest with a rear plate for resting on an edge of a swimming pool, there being holes for the expulsion of air and/or water impelled by one or more pumps located on the headrest, distribution being achieved by means of conduits. Various components included in the chair are articulated, which allows the chair to be folded not only partially but also completely, thereby achieving a reduction in volume not only when the chair is collapsed down when not in use but installed at the swimming pool but also when stored, which transforms it into a device that can be acquired and transported and installed immediately without the need for emptying the swimming pool, and there is no need to assemble the chair which simply has to be unfolded. Provision is made for the distribution of air and/or water by means of rotatable swivel components.

### PURPOSE OF THE INVENTION

This invention relates to a massage chair for pools and all kinds of similar water surfaces, such as classic “Spas” and similar relaxation facilities but without the need for installation of any masonry or emptying of the pool in the event that it is already in operation.

The purpose of the invention is to provide a totally or partially folding chair which also has air and/or water outlet holes so that the user can receive a hydro-masssage during normal use of the chair inside a pool or spa. The possibility of folding implies great advantages for the chair, as it can be sold already mounted (simply unfold and connect to start using it), so that it can be purchased and immediately transported to the place of use and begun operating.

### BACKGROUND OF THE INVENTION

As is known, one of the goals pursued in a pool or spa is to maintain the body at rest while wet for a soothing effect. In this regard there are many floats that allow the user to keep the body partially submerged in water, with a number of limitations in each case that affect either the body posture to be adopted, or the level of body subsidence in the water, as well as comfort.

In particular regard to spas there are devices that simulate a chair or recliner attached to one edge of the water receptacle that could equally be extended to the pool, although there is no precedent in this case.

However, known chair or recliner devices materialize from fixed and immovable structures, which may be well placed at certain times but inappropriate in others, causing a nuisance when they are not used.

To solve the problems and drawbacks discussed above, Spanish utility model ES 1075992 U describes a seat for swimming pools and the like consisting of a body which forms a preferably obtuse dihedral angle, so that the two sectors which form the dihedral angle shape the seat and the back support, the latter extending upwards and on the top surface on a plate projecting backwards and forming an obtuse dihedral angle with the support itself, so that in the working position the seat adopts a horizontal plane.

That rear and upper backrest plate is the means of support for the seat assembly on the edge of the pool.

To maintain the proper position of the chair in use, the armrests should extend in subsequent extensions precisely supporting on the vertical wall of the pool.

The chair thus set up is further complemented with a series of ducts running through the support and through the seat, as well as a front footrest included with said chair or seat, so that using an air or water fluid impeller pump produces hydro-massage effects on the user on the seat.

However, in this way the chair has the drawback that its structure is rigid, so that the space occupied when it is not used in the water is high. This invention solves this problem as it can be folded so that when not in use it can be folded and decreases the floor space used by at least half. It also allows for folding when the chair is not installed aiding transport and further reducing storage costs. These advantages are obtained by the seat having an air and/or water distribution system which permits the folding of the chair using various moving components whose rotation causes the deformation of the pipe network accompanying the respective parts of chair.

### DESCRIPTION OF THE INVENTION

The hydro-massage chair proposed is designed to solve the aforementioned problems, based on a simple but effective solution.

More specifically, the chair invention is mainly characterized by folding, allowing the seat to fold over the back, as well as the back to fold where the plate is set over the edge of the pool, and even the footrest itself with a view that when the chair is not used it is completely folded, does not cause any hindrance and can be stored or placed anywhere without taking up space.

Moreover, the chair invention also has the feature that its folding can be partial, so that said partial fold is used only when the seat is mounted on the edge of the pool but is not intended for use at that time.

Furthermore it is planned that the means for folding the chair at both the footrest and seat and backrest levels, as well as the backrest and the top of the chair and simultaneously with the air and/or water network, are rotating, understanding these as a set of two or more hollow pieces snapping together, or that can be fitted with the aid of an intermediate piece; which allow the relative rotation between them according to a common axis, so that by connecting to one or more of these various parts of the air and/or water conduction system, they conduct fluid through its interior also allowing relative rotation between each part of the system that is connected to a different piece. So the ducts through which the fluid driven by any conventional drive system reach these hinges located at the head of the chair. This distribution is done from the top to the bottom, always passing through the hinges, and reaching not only a grill inside the mid height of the backrest and seat, but another grill located on the footrest, with a bypass duct between the circulation of the backrest with the seat and the joint between this and the footrest. Therefore, the function of the ball join is twofold: to drive fluid from its interior to connect different parts of the distribution system and to serve as a joint to the different parts forming the seat.

It is possible to modify the design of the chair in order that the movement between parts does not rely on a hinge as mentioned above, but rather the different parts of the chair include joints to connect pieces together, so that the air and/or water distribution system can be simplified, without the need to fulfill the function of articulation, so that it can be replaced by a flexible pipe, sized in accordance with the needs of the system, which would be responsible only to absorb deformations in the case of folding the chair. Similarly, it is possible that in certain cases the simultaneous use of the two alternatives becomes necessary for solving specific chair designs required.

In short it is a hydro-massage chair for pools and all kinds of similar water surfaces, which has the distinction of being both fully foldable for storage and partially foldable to not take up space in the pool when not in use, although it is installed on the edge of the pool.

The special configuration of hinges and/or the flexible pipe allows folding of the different parts of the chair and even the passage of air and/or water without any strangulation when folding takes place.

Finally, the chair is made in accordance with the purpose of the invention and does not require any type of masonry or skilled labour for installation. There is also no need to drain the pool for installation resulting in savings of a financial and any other type involve. It can be distributed fully folded in a box that can be carried inside the boot of a car.

### DESCRIPTION OF THE DRAWINGS

To complement the description below and in order to aid a better understanding of the features of the invention, according to a preferred practical embodiment thereof, as an integral part of said description, a set of drawings are attached which in an illustrative and non-limiting manner, represent the following:

FIG. 1.—Shows a representation of a front perspective view of the massage chair made according to the purpose of the invention in the operational position.

FIG. 2.—Displays the same chair, in this case a rear view to show the hinges and distribution of ducts and their connections to the hinges.

FIG. 3.—Shows a view of the different parts or elements constituting each joint between the parts of the chair.

FIG. 4.—Shows a side view of the chair illustrated in FIG. 1.

FIG. 5.—Shows a side view of the chair in the partially folded position.

FIG. 6.—Finally shows a side view of the chair in the fully folded position.

FIG. 7.—Shows a rear perspective view of the fluid line between grills through flexible connections where just the seat, backrest and base are shown to facilitate the visibility of the flexible connections, and where each of the parts of the chair incorporates its own joints, making the use of a hinge unnecessary.

### PREFERRED EMBODIMENT OF THE INVENTION

As seen in the figures, the seat invention comprises a back support (1), a seat (2), a front footrest (3), an upper headrest (4) located above the support itself (1) and side armrests (5).

The upper part relating to the head (4) of the back support (1), includes a plate (6) which in the operational position remains horizontally for support on the edge of a pool and may be fixed to it using through hole screws (7) provided for this purpose on that headrest (4) support plate (6).

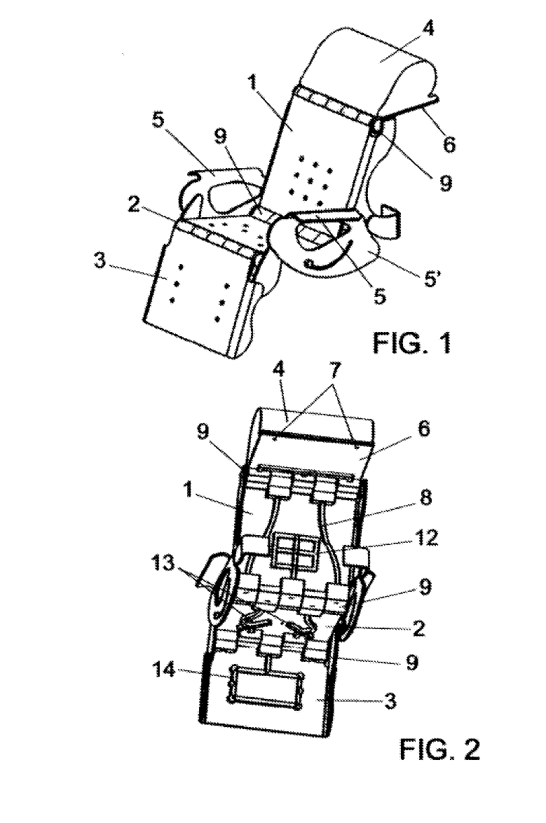

Furthermore, the seat has openings on both the backrest (1), the seat (2) and the footrest (3), as shown in FIG. 1, for the passage of fluid, air and/or water, to provide hydro-massage while using the seat inside a pool, so that fluid can access these holes through the duct (8) in communication with any conventional drive system located just inside the headrest (4).

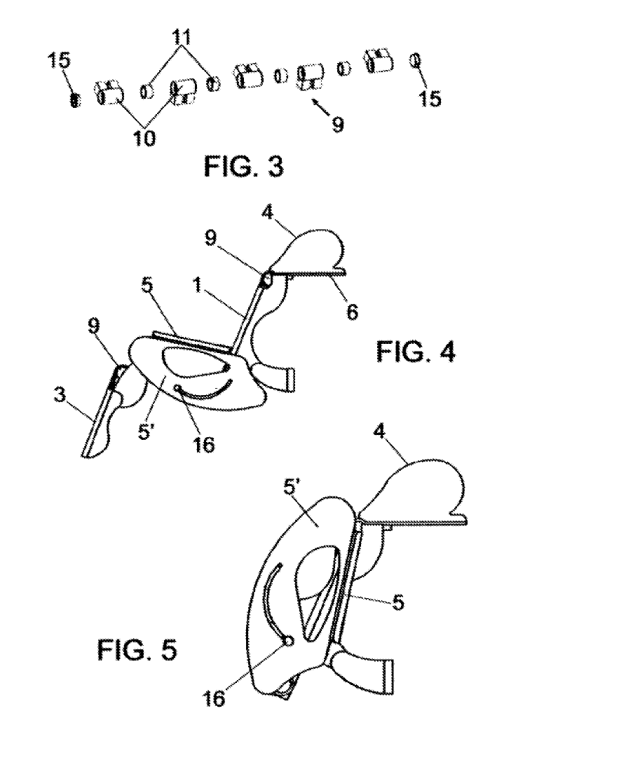

From these features, the novelty of the invention is that the headrest (4) plate (6) is foldable relative to the backrest (1), with the backrest (1) and the seat (2) being equally folding, and even the footrest (3) folding against the seat (2), so that in any case three transverse joints are established each formed by a hinge (9) which can be clearly seen in FIG. 2, with the special feature that each hinge (9) is formed by a plurality of hollow pieces (10) related collaterally to each other through corresponding bushings (11) acting as pivot axes, so that in the assembly of parts (10) when forming the joint (9) present an alternating orientation as clearly seen in FIG. 2, or even in FIG. 3, where we see the dismantled view. Thus, each piece (10) connects a part of the air and/or water distribution system with the hinge (9), depending on the orientation, and likewise each part (10) is coupled with one part or another of the seat.

Ducts (8) through which the flow created by the massage on the seated user immersed in the pool water access the hinges (9), so that the flow delivered by the pump located on the headrest (4) first reaches the joint between the headrest (4) and backrest (1), and from there the fluid is distributed to the hinge located between the backrest (1) and the seat (2), then passing the fluid to the last joint, which is between the seat (2) and the footrest (3). Throughout the described circuit there are various branches which allow the fluid to move from the hinges into the duct grills placed below the outlet ports of each part of the chair.

The air and/or water that reaches the joints (9) is distributed over the back (1) via a grid (12), as shown in FIG. 2, while the distribution over the seat (2) is also performed through another grill or duct bypass (13), with another grill (14) on the footrest (3). All this is so that from the grills or duct configuration (12, 13 and 14) the fluid or air driven by the pump in the headrest (4) can exit through the holes provided for that purpose in the backrest (1) the seat (2) and the footrest (3).

The joints (9) are closed at their ends by plugs (15) to prevent leakage of fluid and creating a chamber in each joint (9) in communication, through the ducts (8), with the chamber forming the next joint, and so forth.

According to these features, the seat may be first partially folded, by folding the seat (2) with the footrest (3) on the backrest (1) itself, in order that the seat assembly occupy about half the space in the pool when not in use.

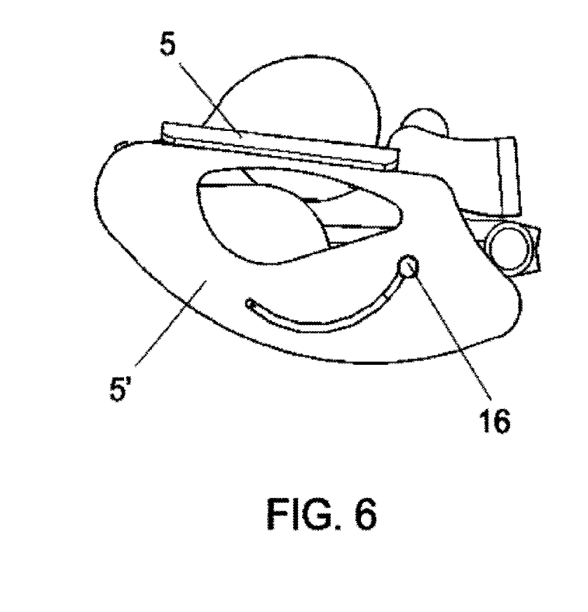

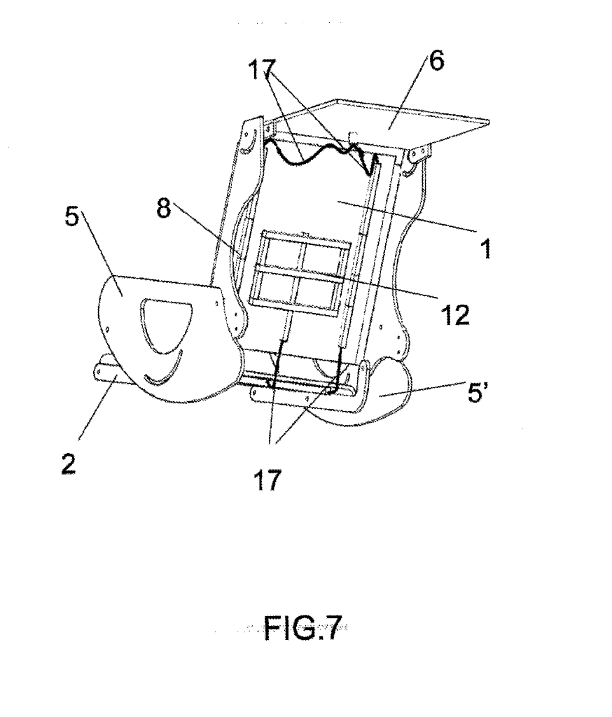

Folding is performed by operating a knob (16) that secures the side (5′) of the armrest (5) to the seat (2) itself, so that when the latter is positioned in the partially folded position, as is shown in FIG. 5, causes the knob (16) to occupy its original position and the chair is stable in this partially folded position, as seen in FIG. 5, while the total folding is done by folding the headrest (4) with the support plate (6) and manual operation provided on one or both sides of the chair, so that in the totally folded position, as shown in FIG. 6, the chair takes up minimum space and can be stored with minimal space occupation.

As mentioned above, if the structure of the chair does not need hinges to be folded, when the different parts to be folded have joint rotation incorporated, the hinges can be replaced by flexible ducts (17), which only have the function of serving as an element which absorbs deformation caused by folding a portion of the air and/or water distribution system against another.

1. A message chair for use in pools and the like, comprising: a backrest and a seat, forming between them an obtuse dihedral angle, the backrest being attached to a headrest and the seat being attached to a foot rest as well as lateral armrests, the chair also having a series of ducts which distribute at least one of air and water driven by a pump located at the headrest for outlet of the at least one of air and water through holes provided in at least one of the backrest, the seat, and the footrest, where both the headrest and the seat are foldable relative to the backrest, with the footrest also being foldable with respect to the seat, permitting partial folding of the seat inside a pool, or total folding for storage, wherein the chair further comprises folding means between the headrest and the backrest as well as between the backrest and the seat, and between said seat and the footrest, respectively, the folding being performable by the respective folding means and the respective folding means each comprising a set of two or more hollow parts engageable with one another or that can be fitted with aid of an intermediate piece; wherein the respective folding means are in communication with the ducts for circulation of the at least one of air and water, wherein the ducts are in correspondence with a duct bypass at the at least one of the backrest, the seat, for distributing the at least one of air and water at the at least one of the backrest, the seat and the footrest with air circuits forming said duct bypass and remaining connected together through the respective folding means, where said duct bypass comprise the holes for the outlet of the at least one of air and water delivered by the pump, with the holes distributed in an area configured to be facing a user and being divided between the at least one of the backrest, the seat, and the footrest.

2. The message chair according to claim 1, wherein the two or more hollow parts of the respective folding means are related collaterally to each other by respective bushings which act as rotation axes, with the two or more hollow parts for each of the folding means arranged in alternate positions so that the respective folding means bind to a corresponding part of the duct bypass.

3. The message chair according to claim 1, wherein each of the respective folding means between the headrest and backrest, between said backrest and seat, and between the seat and the footrest, have their ends closed by plugs to establish for each of the respective folding means fluid communication through the ducts with another of the respective folding means.

4. The massage chair according to claim 1, wherein a connection between an air distribution duct in the chair is made using a flexible connection capable of absorbing deformations caused from folding a part of the chair.

5. The message chair according to claim 2, wherein each of the respective folding means between the headrest and backrest, between said backrest and seat, and between the seat and the footrest, have their ends closed by plugs to establish for each of the respective folding means fluid communication through the ducts with another of the respective folding means.
